(19) United States
(12) Patent Application Publication
(10) Pub. No.: US 2026/0029586 A1
(43) Pub. Date: Jan. 29, 2026

(54) ASSEMBLY OF HOLLOW CORE OPTICAL FIBER WITH MICRO-OPTIC GLASS PLATE FOR CONNECTIVITY AND METHOD OF MAKING SAME

(71) Applicant: CORNING RESEARCH & DEVELOPMENT CORPORATION, Corning, NY (US)

(72) Inventor: Lars Martin Otfried Brusberg, Potsdam (DE)

(21) Appl. No.: 19/243,265

(22) Filed: Jun. 19, 2025

Related U.S. Application Data
(60) Provisional application No. 63/675,315, filed on Jul. 25, 2024.

(51) Int. Cl. G02B 6/38

(52) U.S. Cl. CPC G02B 6/3803; G02B 6/3861

(57) ABSTRACT

An assembly of a hollow-core optical fiber and a micro-optic glass plate enables connections of hollow-core optical fibers to many different types of fiber optics devices (and fibers). The micro-optic glass plate is connected by fusion bonding to the end face of the hollow-core optical fiber, and the micro-optic glass plate covers and seals the fiber from ingress of contaminants that can degrade performance. The micro-optic glass plate can take one of various forms and is at least partially optically transparent to transmit and/or control light energy moving to or from the hollow-core optical fiber. The hollow-core optical fiber is laterally and rotationally aligned on the micro-optic glass plate to help mode match and minimize any coupling and return losses of light energy transferred through the assembly. A method of preparing such an assembly and optical connector systems using the assembly are also provided.

### PRIORITY APPLICATION

This application claims the benefit of priority of U.S. Provisional Application No. 63/675,315, filed on Jul. 25, 2024, the content of which is relied upon and incorporated herein by reference in its entirety.

### TECHNICAL FIELD

This disclosure relates generally to optical fiber systems, and more particularly to assemblies and methods for connecting hollow-core optical fibers to other hollow-core optical fibers and solid-core optical fibers.

### BACKGROUND

Optical fibers are useful in a wide variety of applications, including the telecommunications industry for voice, video, and data transmissions. Benefits of optical fibers include wide bandwidth and low noise operation. Traditional optical fibers include a solid core and a solid cladding that surrounds the core. The core and cladding are typically made of fused silica doped so that the core has a higher index of refraction than the cladding. The core and cladding of the optical fiber are thereby configured to define an optical waveguide that generally confines optical beams propagating through the optical fiber to a region of the optical fiber within and immediately adjacent to the core. The benefits of optical fiber are well known and include higher signal-to-noise ratios and increased bandwidth compared to conventional copper-based transmission technologies.

Hollow-core optical fibers are a newer type of optical fiber that guides light through a hollow air-filled core rather than through a solid silica core. The latest hollow-core optical fiber designs include an anti-resonant structure that can confine light over a broader range of wavelengths as compared to earlier photonic bandgap hollow-core fibers. These anti-resonant structures enable lower-loss transmission over a wider usable wavelength window than previously available from hollow-core optical fibers. A double nested anti-resonant nodeless optical fiber (DNANF) has been reported as having an attenuation level of 0.174 dB/km at 1550 nm, which is comparable to the performance of germanium doped all-glass fibers. In a more recent paper from OFC 2024, a hollow-core DNANF optical fiber was reported as having a loss of less than 0.11 dB/km. Thus, the performance of hollow-core optical fibers has become competitive with traditional solid-core optical fibers for long-haul optical data and signal transmission.

Hollow-core optical fiber has an effective index of refraction similar to that of air. As a result, light propagates through hollow-core optical fiber at essentially the same speed as light in vacuum (300,000 km/sec), which is about 50% faster than the speed at which light typically propagates through solid-core optical fiber (200,000 km/s). Thus, hollow-core optical fiber offers significantly reduced latency compared to solid-core optical fiber. Due to the improvements in signal loss and useable wavelengths resulting from recent research and development, hollow-core optical fiber is becoming increasingly attractive for use in commercial applications.

One problem that continues to impede the use of hollow-core optical fiber is the difficulty in forming connections between hollow-core optical fiber and other optical fibers, including widely deployed standard single-mode (solid core) optical fiber. There continue to be difficulties presented in forming durable and robust connections between such fibers. To this end, current telecommunications systems require connection between the optical fibers and equipment or connection to other fiber optic cables. To provide these connections, fiber optic connectors are often provided on the ends of fiber optic cables to non-permanently connect and disconnect optical elements in a fiber optic network. The process of terminating individual optical fibers from a fiber optic cable is referred to as “connectorization.”

In connectorizing fiber optic cables including one or more hollow-core optical fibers, one specific problem is that the hollow-core optical fiber is more vulnerable to contaminants (e.g., dust, dirt, oils, moisture, particulates, etc.) that may get lodged or trapped inside the hollow core of the optical fiber. The contaminants often impede propagation and degrade performance, and may contribute to interference, noise, or loss. Another problem is that use of certain known types of connectors sometimes cause significant insertion losses of light energy coming from a hollow-core optical fiber, due to back reflection or other deleterious effects. Thus, it would be desirable to provide systems and methods of optically coupling hollow-core optical fibers to other optical fibers in a durable and repeatable manner for field use, while also resulting in a low-loss connection.

### SUMMARY

In one aspect of the disclosure, an assembly is provided for use in fiber optics devices. The assembly includes a hollow-core optical fiber and a micro-optic glass plate connected to the fiber. The hollow-core optical fiber includes an end face at a terminal end thereof. The micro-optic glass plate is fusion bonded to this end face such that the micro-optic glass plate covers the end face (thereby sealing the fiber against contaminants). The micro-optic glass plate is at least partially optically transparent to transmit light energy to or from the hollow-core optical fiber. The hollow-core optical fiber is aligned laterally and rotationally in position on the micro-optic glass plate before the fusion bonding to minimize coupling and return losses of light energy transferred through the assembly. The combination of the fiber and the glass plate therefore provides a robust connector interface for use in connecting the hollow-core optical fiber to other fibers or fiber optics systems in the field.

In one embodiment, the micro-optic glass plate is one of the following: a refractive lens, a meta lens, a beam splitter, a planar glass plate, an angled glass plate, a polarizer, and an isolator. Various functional effects can therefore be provided in the connector being assembled.

In another embodiment, the micro-optic glass plate is laser welded to the end face of the hollow-core optical fiber to fusion bond these elements together. The laser welding produces a bond area that connects and seals the end face to the micro-optic glass plate. For example, the hollow-core optical fiber typically includes an outer cladding surrounding an interior, and the fusion bonded connection is made along a junction of the outer cladding (at end face) with the micro-optic glass plate. In some embodiments, adhesive material may also be included and applied along a junction of an outer periphery—defined by the outer cladding of the fiber—with the micro-optic glass plate after the fusion bonding. The adhesive material further bonds and seals the elements together.

In a further embodiment, the assembly includes an anti-reflective coating applied to at least one surface of the micro-optic glass plate. The anti-reflective coating is configured to minimize back-reflection of light energy transferred through the plate. The micro-optic glass plate can include a first surface connected to the end face of the hollow-core optical fiber and a second surface facing away from the fiber, and the anti-reflective coating can be applied to both of these first and second surfaces.

In yet another embodiment, the assembly defines an optical path for light energy transmission. The assembly advantageously consists of only non-organic materials along the optical path. The use of non-organic material assures high durability by avoiding degradation in performance over the lifetime of the connector, while also handling high levels of power transfer without damage to the assembly.

It will be understood that some embodiments of the assembly include a plurality of hollow-core optical fibers, each having an end face at a terminal end. The micro-optic glass plate can then be connected by fusion bonding to the end faces of each of the plurality of fibers, thereby producing an array of hollow-core optical fibers connected to the micro-optic glass plate. In one particular example, the micro-optic glass plate is a refractive lens array that includes one refractive lens for each of the hollow-core optical fibers connected to the plate. The terminal end of each of the plurality of hollow-core optical fibers can be angle-cleaved as well, leaving the end face oriented at a non-perpendicular angle to a longitudinal length of the fiber. The micro-optic glass plate is connected at the angle to the fibers to thereby minimize back reflection of light energy being transmitted into the micro-optic glass plate.

In another embodiment, the micro-optic glass plate is a lens or a beam splitter. In such a case, the hollow-core optical fiber is aligned laterally before fusion bonding to assure that the lens or beam splitter is positioned to receive all light energy transferred from the hollow-core optical fiber into the micro-optic glass plate. When the micro-optic glass plate is a lens, the hollow-core optical fiber is aligned rotationally before fusion bonding such that a relative angular position of the fiber and the lens is configured to mode match between these elements. As such, coupling losses are minimized for light energy being transmitted between the fiber and the lens on the micro-optic glass plate.

In a further embodiment, the terminal end of the hollow-core optical fiber is angle-cleaved. The micro-optic glass plate can then include an angled glass plate with one surface angled from an opposing surface. When the angled surface is fusion bonded to the hollow-core optical fibers, return losses by reflections are reduced in the coupling.

In a second aspect of the disclosure, an optical connector system for optical data transmission includes a first assembly and a second assembly. The first assembly is similar to the one described above and includes a first hollow-core optical fiber with an end face and a first micro-optic glass plate connected by fusion bonding to the end face of the fiber. The fiber is aligned laterally and rotationally in position on the micro-optic glass plate before the fusion bonding to minimize coupling and return losses of light energy transferred through the first assembly. The second assembly includes a second optical fiber and a second micro-optic glass plate connected to an end face of the second fiber. The optical connector system also includes a connector body configured to receive the first and second assemblies and position the first and second assemblies to define a free space coupling between the first and second micro-optic glass plates. At least one of the micro-optic glass plates includes a lens to guide light energy being transferred between the first and second hollow-core optical fibers.

In some embodiments, the second optical fiber in the system is a solid-core fiber with an inner core configured to transmit light energy and an outer cladding surrounding the inner core. In other embodiments, the second optical fiber is a second hollow-core optical fiber having an open interior surrounded by an outer cladding. In the latter type of embodiment with two hollow-core optical fibers being coupled, the second micro-optic glass plate is fusion bonded to the end face of the second hollow-core optical fiber in a similar manner as described above for the first fiber.

In a further embodiment, the first and second assemblies also include integrated alignment features configured to mate the first assembly to the second assembly. The alignment features allow mating of the assemblies only when the first assembly is laterally and angularly aligned with the second assembly to form the free space coupling.

In a third aspect of the disclosure, a method prepares an assembly for use in fiber optics devices. The method includes cleaving a hollow-core optical fiber to form a terminal end having an end face, with the end face defining an opening into an interior of the fiber. The end face is then positioned into contact with a micro-optic glass plate. The method also includes aligning the end face of the fiber into a desired lateral and angular position relative to the micro-optic glass plate. The end face of the hollow-core optical fiber is fusion bonded to connect it to the micro-optic glass plate. After fusion bonding, the micro-optic glass plate covers and seals the end face of the hollow-core optical fiber. The micro-optic glass plate is at least partially optically transparent to transmit light energy to or from the hollow-core optical fiber. The desired lateral and angular position of the aligning step is configured to minimize coupling and return losses of light energy transmitted through the assembly, thereby providing a durable and reliable connection for use of the hollow-core optical fiber.

In one embodiment, the aligning step is performed by a vision system to automatically and visually guide the end face of the hollow-core optical fiber into the desired lateral and angular position.

In another embodiment, the micro-optic glass plate includes a refractive lens array having one refractive lens for each of a plurality of hollow-core optical fibers. The method then further includes repeating the positioning, aligning, and connecting by fusion bonding steps for each of the plurality of fibers. The fibers are therefore sequentially connected to the micro-optic glass plate to produce an array of hollow-core optical fibers connected and sealed to the micro-optic glass plate. The aligning step positions each hollow-core optical fiber at an associated one refractive lens of the refractive lens array in such embodiments.

In some embodiments, after the connecting by fusion bonding step, the method also includes applying an adhesive material to a junction of an outer periphery of the hollow-core optical fiber with the micro-optic glass plate. The adhesive material increases a strength of the connection between these elements, improving the robustness and reliability for use in the field.

Additional features and advantages will be set forth in the detailed description which follows, and in part will be readily apparent to those skilled in the technical field of optical fiber systems. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a perspective photographic view of an existing multi-fiber array used in a connector for fiber optics devices, with each of the optical fibers being single-mode solid core fibers.

FIG. 2 is a perspective view of a (fiber optic) cable assembly that can include at least one connector having an assembly of a hollow-core optical fiber with a micro-optic glass plate, in one embodiment of the present invention.

FIG. 3 is a diagrammatic cross-sectional view of an exemplary hollow-core optical fiber.

FIG. 4A is a diagrammatic top view of a planar glass plate used as one example of a micro-optic glass plate in accordance with embodiments of the present invention.

FIG. 4B is a diagrammatic top view of another embodiment of a micro-optic glass plate used with the invention, specifically an angled glass plate.

FIG. 4C is a diagrammatic top view of another embodiment of a micro-optic glass plate used with the invention, specifically a refractive lens.

FIG. 4D is a diagrammatic top view of another embodiment of a micro-optic glass plate used with the invention, specifically a meta lens.

FIG. 4E is a diagrammatic top view of another embodiment of a micro-optic glass plate used with the invention, specifically a beam splitter.

FIG. 5 is a diagrammatic top cross-sectional view of an array of hollow-core optical fibers connected to a refractive lens array (serving as the micro-optic glass plate) to form an array assembly in this embodiment.

FIG. 6 is a diagrammatic end view of a refractive lens and a hollow-core fiber before and after fusion bonding connection together, showing specifics of a bonding area formed by the connection.

FIG. 7A is a diagrammatic top cross-sectional view of a first step in an assembly process for making the array assembly shown in FIG. 5, with a first hollow-core optical fiber being laser welded to fusion bond the end face thereof to the micro-optic glass plate.

FIG. 7B is a diagrammatic top cross-sectional view similar to FIG. 7A but showing a second step in the assembly process, specifically including laser welding a second hollow-core optical fiber to the micro-optic glass plate.

FIG. 7C is a diagrammatic top cross-sectional view similar to FIG. 7B but showing a third step in the assembly process, specifically including laser welding a third hollow-core optical fiber to the micro-optic glass plate.

FIG. 7D is a diagrammatic top cross-sectional view similar to FIG. 7C but showing a fourth step in the assembly process, specifically including laser welding a fourth hollow-core optical fiber to the micro-optic glass plate.

FIG. 7E is a diagrammatic top cross-sectional view similar to FIG. 7D but showing a fifth step in the assembly process, specifically including apply adhesive material to further strengthen the connection of all hollow-core optical fibers to the micro-optic glass plate.

FIG. 8 is a diagrammatic top cross-sectional view of an array of hollow-core optical fibers connected to a refractive lens array similar to that in FIG. 5, but with the hollow-core optical fibers having an angled cleave and an angled connection to the refractive lens array.

FIG. 9 is a perspective view of one of the connectors of the cable assembly of FIG. 2, the connector terminating a fiber optic cable and designed for coupling to a connector on another cable assembly.

FIG. 10 is a schematic diagram showing an optical connector defined by a free space coupling formed between a first optical fiber that is a hollow-core optical fiber and a second optical fiber that is also a hollow-core optical fiber, using one or more of the assemblies according to the invention.

FIG. 11 is a schematic diagram showing an optical connector defined by a free space coupling formed between a first hollow-core optical fiber and a second solid-core single mode fiber.

FIG. 12 is a schematic diagram of an optical connector similar to that in FIG. 11 but with an expanded free space coupling between the fibers.

FIG. 13 is a schematic diagram of an assembly of a hollow-core optical fiber with an angled glass plate as the micro-optic glass plate, shown both with and without anti-reflective coatings.

FIG. 14 is a schematic diagram of an optical connector defined by a free space coupling formed between the assembly of FIG. 13 (including a first hollow-core optical fiber) and a second solid-core single mode fiber.

FIG. 15 is a flowchart illustrating steps of a method of assembling an optical fiber connector which may include an array of hollow-core optical fibers with a micro-optic glass plate.

FIG. 16 is a perspective view of a known optics connector with a graphical plot showing insertion (coupling) loss of light energy caused at various angular positions of the portions of the optics connector.

It should be understood that the appended drawings are not necessarily to scale and may present a somewhat simplified representation of various features illustrative of the basic principles of the disclosure. For example, certain features illustrated by the drawings may be enlarged or distorted relative to others to facilitate visualization and a clear understanding.

### DETAILED DESCRIPTION

Various embodiments will be further clarified by examples in the description below. In general, the description relates to assemblies and methods that enable hollow-core optical fibers to be coupled to both solid-core optical fibers (e.g., a standard single-mode optical fiber) and to other hollow-core optical fibers. By combining the hollow-core optical fiber with a micro-optic glass plate, high power optical transmissions can be handled with minimized coupling and return losses, while also providing a highly durable and consistent connector for use in various fiber optics fields.

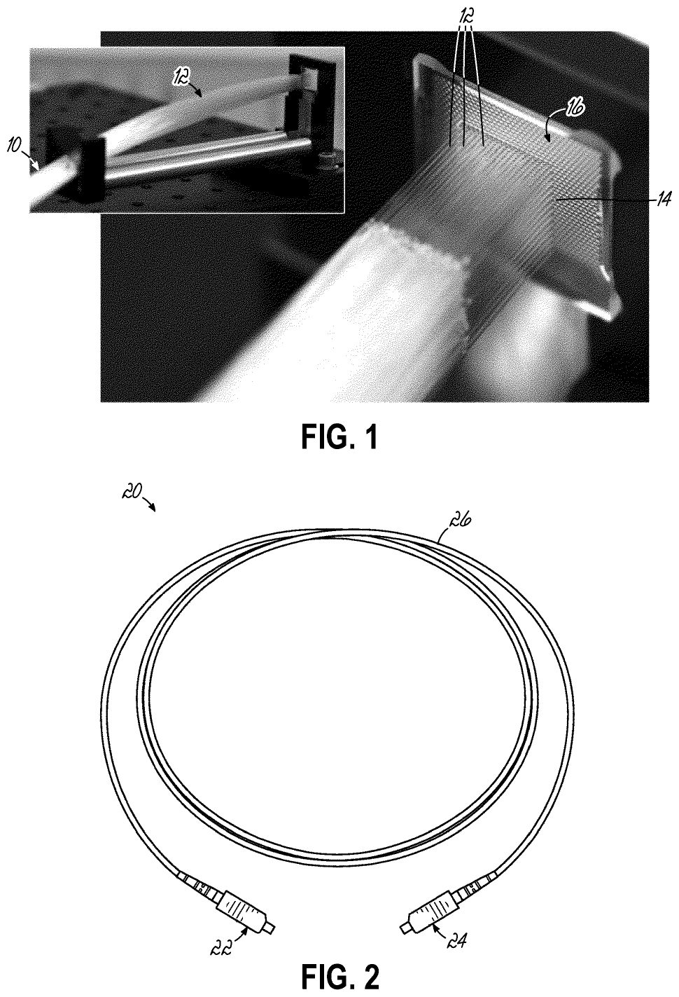

Two specific use contexts for the assembly of the present disclosure are shown in the views of FIGS. 1 and 2. Beginning with reference to FIG. 1, a cable 10 may be provided with a plurality of optical fibers 12, and each of these optical fibers 12 may be terminated and connected—such as by CO₂ laser bonding—to a micro lens array 14 to produce a high-density optical connector 16 as shown in the detailed photograph provided in this illustration. The example shown in FIG. 1 contains five hundred optical fibers 12 in this densely packed array. Although the optical fibers 12 from this particular photograph are single-mode (solid-core) fibers in this example, the embodiments described below will explain how a similar optical array can now be successfully formed when using hollow-core optical fibers in place of the single-mode fibers, thereby leveraging the added functionality and benefits of hollow-core optical fibers.

FIG. 2 depicts an embodiment of a cable assembly 20 in accordance with embodiments of the present disclosure. The cable assembly 20 may be connectorized along both ends thereof. As used herein, the term “connectorized” refers to an embodiment where the cable assembly 20 is prepared for coupling to or plugging into an optical receptacle or a connector on another cable assembly to create a mechanical coupling for optical data transmission between the cable assembly 20 and the other element. As depicted in FIG. 2, the cable assembly 20 is connectorized with a first connector 22 at a first end and a second connector 24 at a second end. A length of fiber optic cable 26 extends between the first connector 22 and the second connector 24. In one or more embodiments, the fiber optic cable 26 has a length of up to 100 meters. As such, the cable assembly 20 can be used in various applications, including as a “patchcord” traversing small lengths between data centers, in one example, or as a long-run coupling between two electronic components located at significant distance from each other. It will be understood that the first and second connectors 22, 24 as shown can include a micro-optic glass plate and a hollow-core optical fiber (described in further detail below) to provide several functional advantages associated with successfully using hollow-core optical fibers in these settings and applications.

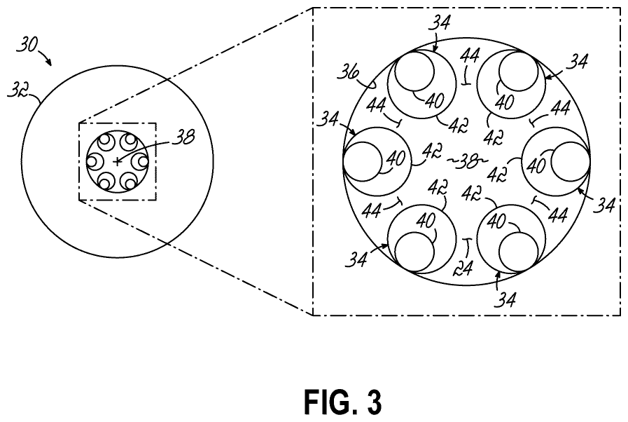

As described above, the assembly and systems of this disclosure advantageously include at least one hollow-core optical fiber 30. FIG. 3 depicts a cross-sectional axial view of an exemplary hollow-core optical fiber 30. The hollow-core optical fiber 30 includes an outer cladding 32 and a plurality of structural tubes 34 (also referred to as capillaries) arranged circumferentially on an inner surface 36 of the cladding 32 to define a hollow core 38 (also referred to as an interior 38 of the hollow-core optical fiber 30). The depicted embodiment includes six structural tubes 34 each having a nested structure comprising an inner tube 40 and an outer tube 42. It should be understood, however, that the fiber optic coupling systems and methods disclosed herein may be used with any type of hollow-core optical fiber and are therefore not limited to hollow-core optical fibers including any number of structural tubes or structural tubes that are nested.

The cladding 32 and structural tubes 34 may be formed, for example, of doped or undoped silica glass. The dimensions of the elements of the hollow-core optical fiber 30 may be selected so that adjacent structural tubes 34 are separated by a gap 44. The gap 44 may prevent adjacent structural tubes 34 from contacting each other. The dimensions and other characteristics of the cladding 32 and structural tubes 34 (e.g., the refractive index) may be selected to define a waveguide that generally confines optical beams propagating through the hollow-core optical fiber 30 to the hollow core 38. The thickness of the walls of the structural tubes 34 may also be selected to provide an anti-resonant effect that reduces leakage of optical beams from the hollow core 38 into the structural tubes 34. However, the fiber optic systems and methods disclosed herein are not limited to hollow-core optical fibers having any particular set of structural dimensions (indeed, the assemblies described herein can work with hollow-core optical fibers having diameters ranging from at least 80 μm to 500 μm).

The combination of the hollow-core optical fiber 30 with a micro-optic glass plate 50 according to the embodiments of this disclosure both blocks the open interior 38 shown in FIG. 3 from debris and contamination and configures the hollow-core optical fiber 30 for efficient, loss-minimized transmission of light energy. To this end, the micro-optic glass plate 50 is adapted to help successfully connectorize the unique structural and light transmission modes from a hollow-core optical fiber 30. Several examples of how this combination can be made follow after describing some options for the micro-optic glass plate 50 and its construction.

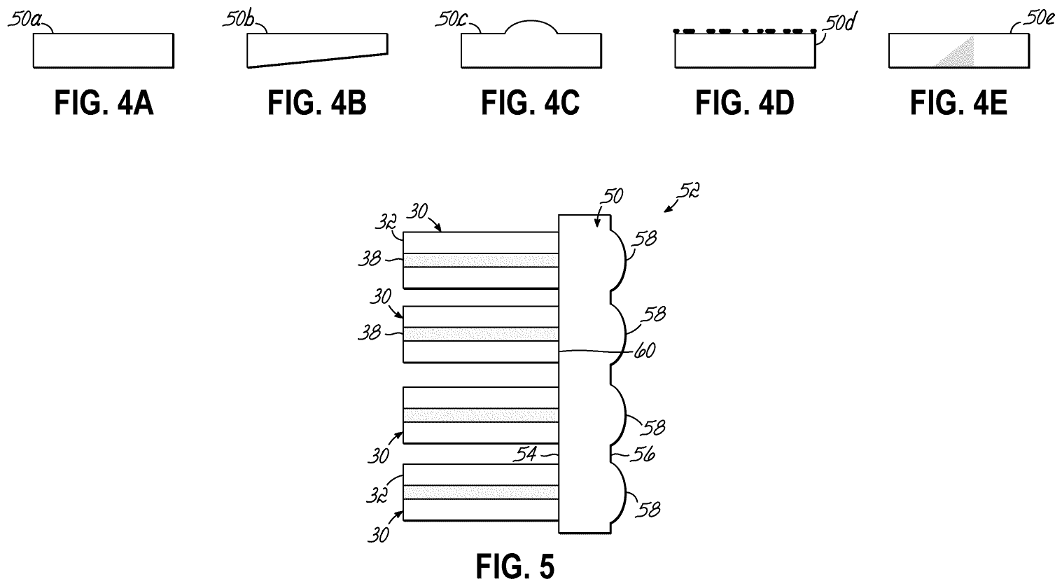

FIGS. 4A-4E illustrate several examples for a micro-optic glass plate 50 that may be joined with a hollow-core optical fiber 30 in accordance with embodiments of this disclosure. Some of these will be shown again in further examples below where a coupling is made with a hollow-core optical fiber 30. FIG. 4A shows that the micro-optic glass plate 50a is a planar glass plate, which is generally defined by having front and rear surfaces that are generally parallel to one another. FIG. 4B shows that the micro-optic glass plate 50b is an angled glass plate, which is generally defined by having front and rear opposing surfaces angled from one another. FIG. 4C shows that the micro-optic glass plate 50c is a refractive lens, which includes a typically rounded lens contour along one surface to redirect and/or focus light energy transmitted through the plate 50c. FIG. 4D shows that the micro-optic glass plate 50d is a meta lens, which includes meta-surface structures along at least one side to achieve various light control and focusing. FIG. 4E shows that the micro-optic glass plate 50e is a beam splitter, which is one type of glass substrate having internal structures for designed optical functionalities. It will be understood that these are just several examples of what the micro-optic glass plate 50 may contain (others not illustrated include a polarizer or an isolator), but each of these is generally defined by being a thin plate of material that can cover and seal an end face of the optical fiber that the micro-optic glass plate 50 is attached to, while also being at least partially optically transparent.

To this end, it is typically desirable that the micro-optic glass plate 50 be as thin as possible to limit the length of space through which light energy must be transmitted after exiting (or before entering) the hollow-core optical fiber 30. It is possible in some of the examples provided in FIGS. 4A-4E to thin the micro-optic glass plate 50 further after bonding to an optical fiber. Regardless, the micro-optic glass plate 50 preferably defines a thickness of 10 μm to 1 mm (but this thickness could still be larger in certain embodiments) in the examples provided in this disclosure. One example of a material that could be used to form the micro-optic glass plate 50 is the thin, flexible Willow® Glass commercially available from Corning Incorporated, of Corning, New York, United States, the original Applicant of the present application. However, other types of glass, polymer, or thin films may suffice for this objective (and the additional functionalities desired including at least partial optical transparency)—e.g., the use of the term “glass” in the term micro-optic glass plate 50 should not be deemed as a material limitation. Furthermore, it is desirable that the micro-optic glass plate 50 be formed from material exhibiting a scratch resistance or hardness sufficient to allow the micro-optic glass plate 50 to remain free from markings or scratches that could adversely affect the optical transparency and transmission of light energy through the micro-optic glass plate 50.

One example embodiment is shown in FIG. 5 of an assembly 52 implementing connections of at least one hollow-core optical fiber 30 to a micro-optic glass plate 50, specifically in the form of a refractive lens array. The refractive lens array serving as the micro-optic glass plate 50 includes a rear surface 54 facing towards the hollow-core optical fibers 30, a front surface 56 facing away from the fibers 30, and a plurality of rounded lenses 58 formed along the front surface 56. The pitch or spacing of the lenses 58 may be, in one example, about 250 μm, but this pitch could be larger or smaller in other example embodiments. The plurality of hollow-core optical fibers 30 must be connected to the refractive lens array using the same pitch to align with the lenses 58, and as such, it is desirable to use direct fusion bonding to join these elements together as described further below. The direct fusion bonding does not require any intermediate material and thus keeps the thickness through which light energy must move as small as possible at the micro-optic glass plate 50, while also allowing for small spacings to achieve a pitch of fibers 30 matching the lenses 58. Although only one dimension and several of the lenses 58 are shown in this schematic illustration of FIG. 5, it will be understood that the refractive lens array can be one-dimensional (a row) or two-dimensional and have a significant number of fibers 30 and lenses 58, such as the one provided as an initial example previously at FIG. 1. The assembly 52 of this and other embodiments can advantageously work with hollow-core optical fibers 30 having diameters ranging anywhere from 80 μm to 500 μm.

The components of the assembly 52 can be prepared for the connection together using some or all of the following steps. The lenses 58 can be formed on a wafer or panel level of the micro-optic glass plate 50 using known lithographic processes with sub-micron precision to properly position and pitch each lens 58. Moreover, the refractive lens array can be diced, or laser cut, before or after the fusion bonding to the hollow-core optical fibers 30. The hollow-core optical fibers 30 can be prepared using standard mechanical tools, or alternatively, with advanced fiber stripping and cleaving methods such as laser cleaving. The hollow-core optical fiber 30 is typically supplied from a spool containing up to hundreds of meters of fiber length, or spools of cable. The cleaving can be straight or angled as will be described throughout the examples of this disclosure. Once the hollow-core optical fiber 30 (or cable) is cleaved to cut it to a desired length, the terminal ends of the hollow-core optical fiber 30 can be connectorized for coupling to a light source or other fiber optics components. It is preferred that the wavelength of any light source used with the example shown in FIG. 5 be matched to the design of the lenses 58 for best alignment and connection efficiency.

After the hollow-core optical fibers 30 and the micro-optic glass plate 50 have been prepared, alignment of these elements is performed to properly position each hollow-core optical fiber 30 on the micro-optic glass plate 50 (in this example, aligned as desired laterally and angularly with the corresponding lens 58 on the front surface 56). Vision alignment based primarily on dimensions of the components is possible. However, it is better to use an active automated alignment with a vision system (not shown) to actively align the hollow-core optical fibers 30 to the correct positions on the rear surface 54. A beam analyzer can be used to detect an optical signal coming through the hollow-core optical fiber 30 to provide information to the vision system for performing accurate alignment and positioning of the fiber 30. Once the hollow-core optical fiber 30 is aligned laterally and angularly, the end face 60 of the hollow-core optical fiber 30 (produced at a terminal end when the fiber 30 is cleaved) is permanently bonded to connect to the micro-optic glass plate 50 specifically along the rear surface 54. Each hollow-core optical fiber 30 may be aligned and then connected sequentially to arrive at the completed version of the assembly 52 shown in FIG. 5.

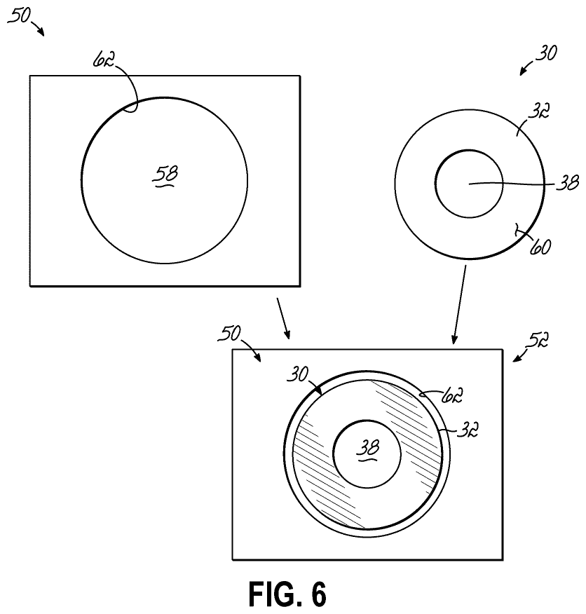

FIG. 6 illustrates how the fusion bonding can be completed at each of the hollow-core optical fibers 30 in this and other embodiments. On the upper left in FIG. 6, a portion of the refractive lens assembly included in the micro-optic glass plate 50 is shown, and the micro-lens aperture 62 of the lens 58 is shown as a circle on this micro-optic glass plate 50. On the upper right in FIG. 6 is a front view of the end face 60 of the hollow-core optical fiber 30 that is to be connected at the micro-lens aperture 62, with the outer cladding 32 shown surrounding the hollow interior 38. The alignment of these components results in the generally centered positioning shown at the bottom portion of FIG. 6.

The connection or fusion bonding is completed in one example by laser welding the end face 60 at the outer cladding 32 to the rear surface 54 of the micro-optic glass plate 50. This laser welding can be done without contacting the micro-optic glass plate 50 and without insertion of an intermediate material. This connection is possible because the outer cladding 32 and the micro-optic glass plate 50 are both typically formed from glass materials such as fused silica, borosilicate, aluminosilicate, alkali glasses, or the like . . . and such materials can be permanently fusion bonded using the laser welding. The laser welding forms a bond area 64 (such as a weld line) as shown in shaded profile in FIG. 6, and this bond area 64 can advantageously be at all areas of the juncture of the outer cladding 32 at end face 60 with the micro-optic glass plate 50 at the micro-lens aperture 62. Although the bond area 64 is shown over the entire juncture in this view, it will be understood that the bond area/weld line 64 can be any shape or profile based on the movement and operation of the laser performing the laser welding. The bond area 64 preferably forms a continuous, closed periphery that seals an opening into the interior 38 of the hollow-core optical fiber 30 at the end face 60 (thereby preventing contaminants from entering and adversely affecting the operation/function of light transmission through the fiber 30).

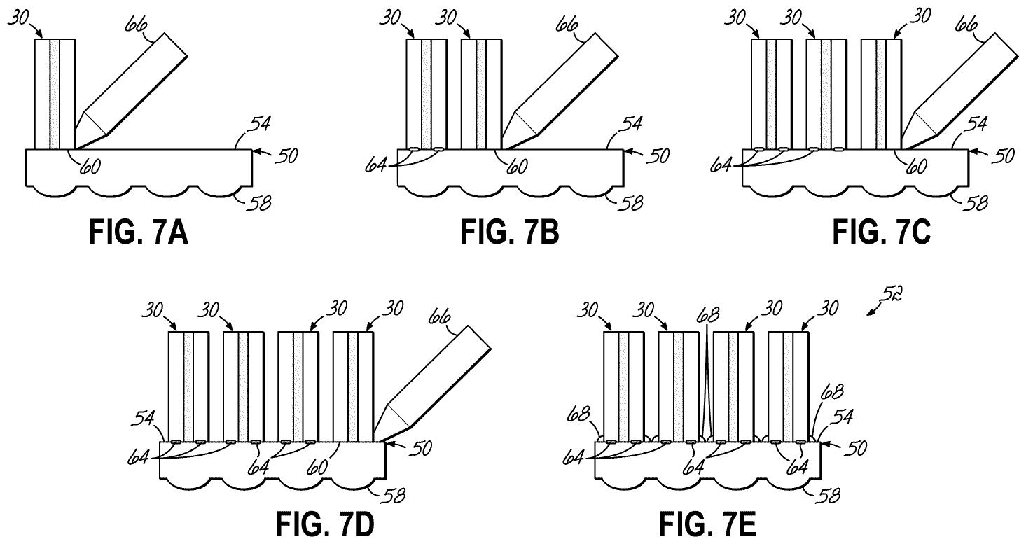

Now turning with reference to FIGS. 7A-7E, a stepwise process for manufacturing the assembly 52 is shown in further detail. Starting with FIG. 7A, a first hollow-core optical fiber 30 is actively aligned laterally and angularly with one of the lenses 58 on the refractive lens array defining the micro-optic glass plate 50 of this example. A laser 66 then performs laser welding to close any gap between the end face 60 of the first hollow-core optical fiber 30 and the rear surface 54 of the micro-optic glass plate 50. The laser welding mechanically couples these elements together in the desired alignment and position, and further provides a solid interface to seal the interior 38 of the hollow-core optical fiber 30 from debris or contaminants. The bond area 64 joining the first hollow-core optical fiber 30 to the micro-optic glass plate 50 is shown in FIG. 7B, in exaggerated form for illustration purposes.

The process then continues at FIG. 7B by contacting a second hollow-core optical fiber 30 with the micro-optic glass plate 50 and aligning this second fiber 30 to another lens 58 on the refractive lens array. The laser 66 performs laser welding to fusion bond the second hollow-core optical fiber 30 in position, and this contacting, aligning, and bonding is repeated then for a third hollow-core optical fiber 30 (in FIG. 7C) and a fourth hollow-core optical fiber 30 (in FIG. 7D) in sequence. Although the laser 66 is shown performing sequential bonding from one side of each of the hollow-core optical fibers 30 in these views, it will be understood that multiple laser beams coming from different sides of the fibers 30 or the glass plate 50 are also possible for enhanced manufacturing efficiency. Finally in FIG. 7E, all of the hollow-core optical fibers 30 are fusion bonded to connect them to the micro-optic glass plate 50, and a further optional step of applying an adhesive material 68 can then be performed.

In this regard, adhesive material 68 can be locally dispensed at a junction of an outer periphery defined by the outer cladding 32 of each of the hollow-core optical fibers 30 with the rear surface 54 of the micro-optic glass plate 50. The adhesive material 68 after curing increases the strength (pull force) of the connection between the plurality of hollow-core optical fibers 30 and the micro-optic glass plate 50. In dense arrays containing many fibers such as set forth in FIG. 1, providing the adhesive material 68 can be important for allowing handling in the field without disrupting the connections of the elements in the assembly 52. It will be appreciated that the adhesive material 68 is only applied after the fusion bonding is completed so that the adhesive material 68 cannot flow past the bond areas 64 into the interior 38 of any of the hollow-core optical fibers 30. With this step completed in FIG. 7E (for all fibers 30), the assembly 52 is completed and ready for incorporation into a fiber optic connector or a similar device.

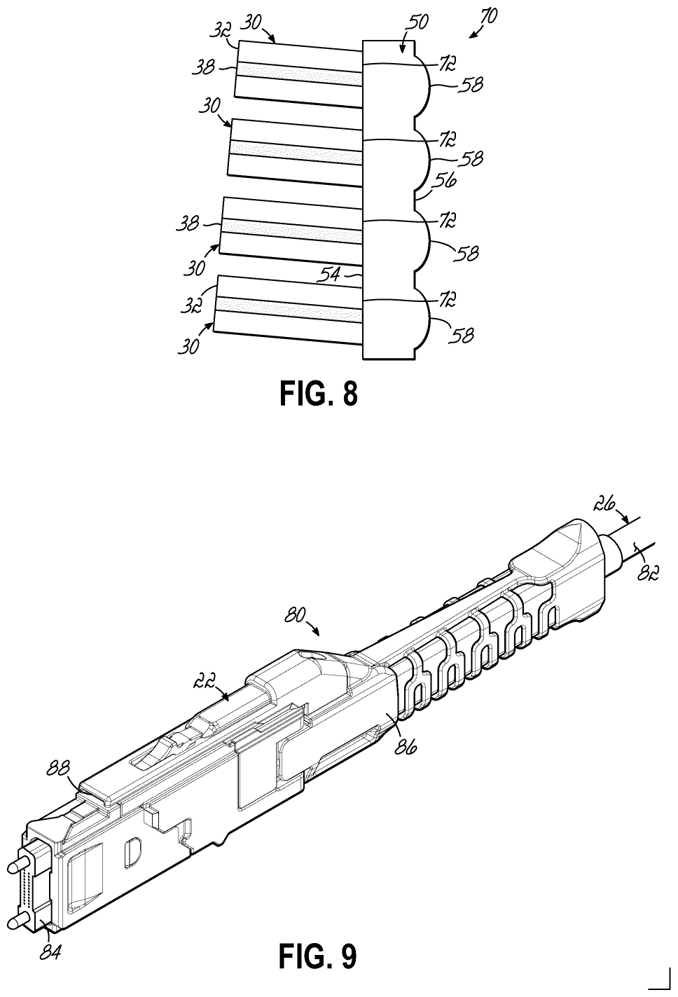

FIG. 8 shows another alternative version of the assembly 70 in which a similar micro-optic glass plate 50 (forming a refractive lens array with several lenses 58) is connected to a plurality of hollow-core optical fibers 30. In this alternative, each of the hollow-core optical fibers 30 is angle-cleaved such that the (angled) end face 72 must be joined at an angle to the longitudinal length of the hollow-core optical fiber 30. By connecting the hollow-core optical fibers 30 at an angle, any back reflection caused by light energy moving through the interface with the micro-optic glass plate 50 is avoided and this can avoid a potential Fresnel loss of up to 0.3 dB in this connection. It will be understood that angle cleaving and angled connections can be applied in any embodiment of this disclosure to avoid or minimize any potential signal/light losses.

Any of the assemblies described above or in the coupling examples below can be incorporated as part of an optical connector system 80, one example of such being shown in FIG. 9. The optical connector system 80 can include one of the first or second connectors 22, 24 as previously described in the cable assembly 20 (reference 22 used in this FIG. 9). The cable 26 of this embodiment in FIG. 9 carries a plurality of optical fibers, specifically including at least one hollow-core optical fiber 30 (not visible), all within an outer jacket or sheath 82. These optical fibers are terminated at their ends within the connector 22, sometimes including at a ferrule 84 located at least partially within a connector body 86 (also sometimes referred to as a housing assembly). The connector body 86 includes structural elements at a leading end 88 thereof for mechanically coupling to an optical fiber receptacle or another connector, thereby enabling optical data transmission to the connected element. In this regard, the connector 22 is designed to create an optical connection for transmission of light energy when the mechanical coupling is completed. The connector body 86 may define strain relief elements and other known components as will be well understood in the fiber optics field. It will be understood that the micro-optic glass plate 50 is connected to the terminal end(s) of all the hollow-core optical fiber(s) 30 and incorporated into the connector 22 (such as around the ferrule 84) to allow for the exemplary couplings of cable assemblies noted in further examples below.

Before turning to those next examples, it is noted that the micro-optic glass plate 50 and all components defining an optical path for light energy movement through the assembly 52, 70 should consist of only non-organic materials in these embodiments. Removing organic materials from the optical path assures that there will be no degradation in transmission performance over the lifetime of the assembly 52, 70 and any connector systems 80 that the assembly 52, 70 is incorporated into. Furthermore, high levels of optical power or light energy can be transmitted through the assembly 52, 70 without causing degradation or other issues in the non-organic materials. While it is preferred that all components described in this disclosure be formed from non-organic materials, other alternatives are possible so long as the optical path remains free from organic materials.

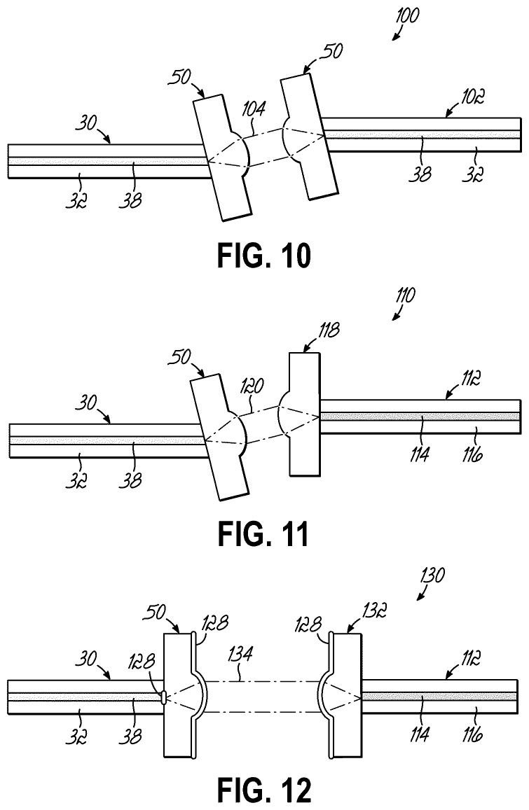

Now turning with reference to FIGS. 10-14, several example optical connectors are shown which define free space couplings between two fibers using the assemblies according to the present disclosure. Each of these is briefly described to show the variations possible when using the advantageous assembly of a hollow-core optical fiber 30 with a micro-optic glass plate 50.

In FIG. 10, a first hollow-core optical fiber 30 is coupled in a free space coupling to a second hollow-core optical fiber 102, specifically to form an optical connector 100. In this and the next examples, the surrounding connector body structure is not shown so that the focus can be on the optical path and the elements defining same in these optical couplings. Each of the first and second hollow-core optical fibers 30, 102 is angle-cleaved and connected to a micro-optic glass plate 50 in the form of a refractive lens. Light energy movement through the free space coupling of this optical connector 100 is shown by beam lines 104 in FIG. 10. It will be understood that the collimated beam diameter in this region is in the range of 10 μm to 500 μm, with the specific diameter dependent on parameters including lens radius of curvature, mode field of the fibers, and other glass parameters of the micro-optic glass plates 50. Thus, an expanded free space coupling that is durable and reliable is formed between two hollow-core optical fibers 30, 102 in this embodiment.

FIG. 11 shows a similar free space coupling but using a second fiber that is a solid-core single-mode fiber 112. In this regard, the optical connector 110 includes the first hollow-core optical fiber 30 connected by fusion bonding to a refractive lens serving as a micro-optic glass plate 50. The optical connector 110 also includes the single-mode fiber 112 which has a solid core 114 surrounded by an outer cladding 116, and this single-mode fiber 112 is also connected (by fusion bonding or the like) to another micro-optic glass plate 118 in the form of a refractive lens. In this example, the single-mode fiber 112 is straight-cleaved and connected in a non-angled interface with its refractive lens 118, while the hollow-core optical fiber 30 is angle-cleaved and joined at an angled interface to its micro-optic glass plate 50. The micro-optic glass plates 50, 118 will be different to achieve the same collimated beam for transmission by the two different types of fiber 30, 112, and this achieves a low-loss coupling. The beam lines 120 show light movement across the free space coupling in this example of an optical connector 110.

In FIG. 12, another feature of some embodiments of the assembly is shown, that being the application of an anti-reflective coating 128. The optical connector 130 of this example is once again a free space coupling between a first hollow-core optical fiber 30 and a second fiber in the form of a single-mode fiber 112. The first hollow-core optical fiber 30 is connected to the micro-optic glass plate 50 in a non-angled interface in this example, and a similar non-angled interface is again formed between the single-mode fiber 112 and the micro-optic glass plate 132 (again a refractive lens) to which it is connected. The anti-reflective coating 128 is applied to one or both sides of each of the micro-optic glass plates 50, 132 to minimize back reflection and avoid signal losses, which enables a longer distance free space coupling as schematically shown in this view. Beam lines 134 are again shown to illustrate light energy movement across the free space coupling in the optical connector 130.

More particularly, the assembly on the right side of FIG. 12 between the single-mode fiber 112 and the micro-optic glass plate 132 includes an anti-reflective coating applied along an outer surface facing towards the other assembly and the hollow-core optical fiber 30. This will avoid reflections caused at the air-glass interface, but it will be appreciated that the interface on the opposing surface of the micro-optic glass plate 132 may not be needed, e.g., when the lens glass and the fiber glass materials are index-matched. One such example of materials could be fused silica defining the micro-optic glass plate 132 and fused silica defining the single-mode fiber 112. For the assembly on the left side of FIG. 12 between the hollow-core optical fiber 30 and the micro-optic glass plate 50, the anti-reflective coating 128 is applied both at the outer surface (again at an air/glass interface) and along a localized portion of the inner surface. More particularly, the anti-reflective coating 128 can be applied at the air/glass interface located at the opening into the interior 38 of the hollow-core optical fiber 30, as such an interface can be prone (especially in non-angled junctions) to reflections of energy. Thus, anti-reflective coatings 128 can be applied selectively to one or both surfaces of the micro-optic glass plate to achieve desired operational results (and low coupling losses).

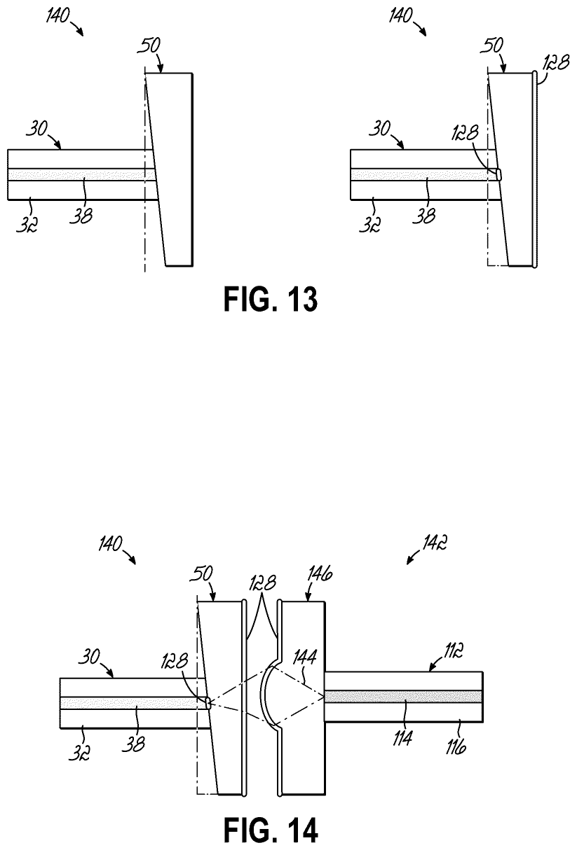

FIG. 13 shows an example where the hollow-core optical fiber 30 is angle-cleaved and connected at an angle to a micro-optic glass plate 50 defined by an angled glass plate to form an assembly 140. The angle of the rear surface 54 of the micro-optic glass plate 50 is shown by the phantom vertical lines provided in this view. The angle can be in the range of 2 degrees to 10 degrees to help minimize back reflection and return loss of light energy. To enhance this function, the anti-reflective coating 128 can again be applied on both sides of the micro-optic glass plate 50 as shown in the right view in FIG. 13—but it will be understood that the angled interface may dispense with the need for added anti-reflective coating 128 as shown in the left view of FIG. 13.

The assembly 140 shown in FIG. 13 is incorporated into an optical connector 142 defining a free space coupling (or potentially a contact coupling) with a single-mode fiber 112 connected to a different type of micro-optic glass plate 146 (a refractive lens) than the angled glass plate connected to the hollow-core optical fiber 30. Thus, this example shows that different types of micro-optic glass plates 50, 146 may be used on opposite sides of the coupling. The refractive lens in the micro-optic glass plate 146 focuses the light to match the mode of the hollow-core optical fiber 30. The distance (or lack thereof in a contact coupling) and alignment between the micro-optic glass plates 50, 146 is achieved with integrated alignment features (not shown) like bores, holes, pins, for passive alignment in all dimensions relative to one another-lateral and angular alignments. Once aligned, the light energy can transmit across the optical connector 142 as shown by beam lines 144 in this Figure. Anti-reflective coating 128 is again applied in this example. The examples shown in FIGS. 10-14 are just several examples of the optical connectors and couplings that can be successfully formed using a hollow-core optical fiber 30 when applying the assemblies and methods of this disclosure, but it will be understood that any such combination of different types of micro-optic glass plate and fibers can be made as these examples show.

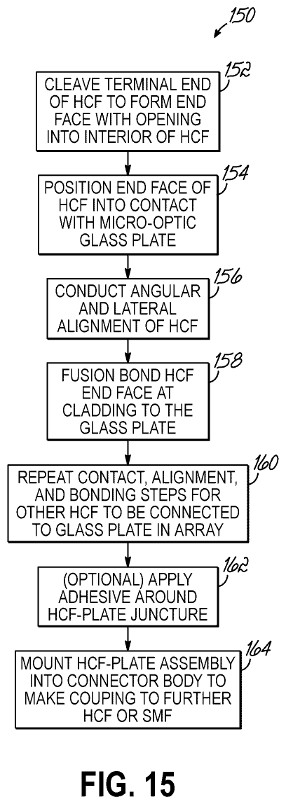

An exemplary process 150 for preparing an assembly according to the embodiments of this disclosure (and consistent with the many examples provided above) is shown in a flowchart form in FIG. 15. The process 150 starts at step 152 with cleaving a terminal end of a hollow-core optical fiber to form an end face that defines an opening into the interior of the hollow-core optical fiber. At step 154, the end face of the fiber is positioned into contact with a micro-optic glass plate. Then, at step 156, alignment is conducted to assure a desired lateral and angular alignment of the hollow-core optical fiber relative to the micro-optic glass plate. The alignment is configured to mode match and minimize any coupling and/or return losses that would occur from light energy or signals transmitted from the fiber through the micro-optic glass plate. Next, the end face is connected to the micro-optic glass plate by fusion bonding these elements together at step 158. The micro-optic glass plate then covers and seals the end face of the hollow-core optical fiber, but the micro-optic glass plate is at least partially transparent to transmit light energy to or from the hollow-core optical fiber as is desired in making optical couplings.

The process continues at step 160 with a repeating of the positioning, aligning, and connecting by fusion bonding steps for each of a plurality of hollow-core optical fibers. This repeating of steps sequentially connects the plurality of fibers to a shared micro-optic glass plate, thereby producing an array of hollow-core optical fibers connected and sealed to the micro-optic glass plate. In embodiments where the micro-optic glass plate is a refractive lens array, the aligning positions each hollow-core optical fiber at an associated one refractive lens in the refractive lens array. Optionally, the process can then continue at step 162 by applying adhesive material around the junctures of the hollow-core optical fibers and the micro-optic glass plate. The adhesive material strengthens the connection and the pull strength of the assembled elements. Finally, at step 164, the assembly of the hollow-core optical fiber(s) and the micro-optic glass plate is mounted into a connector body to prepare for making a coupling to a further fiber optic cable or device (which may include a single-mode fiber or another hollow-core optical fiber). The process 150 results in an assembly and/or a connector that can leverage the many advantages of using hollow-core optical fibers while mitigating the difficulties and drawbacks currently experienced with trying to incorporate such fibers in optical networks.

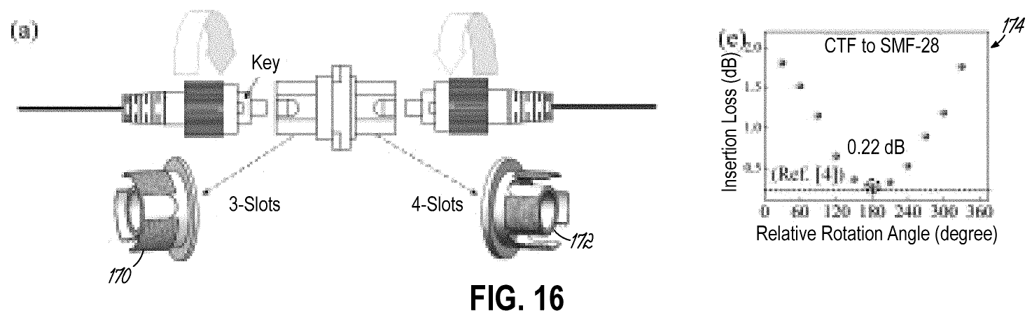

With reference to FIG. 16, an optics connector is shown with a graphical plot illustrating the importance of proper angular alignment when incorporating the hollow-core optical fibers 30 into an assembly or connector. The optics connector for joining two fibers (at least one of which is a hollow-core optical fiber 30) in FIG. 16 includes a mechanical slot mating sleeve that enables the connector portion on the left to align in 12 different rotational positions relative to the connector portion on the right. To this end, the particular mechanical slot mating sleeve includes a 3-slot connector cap 170 on one side and a 4-slot connector cap 172 on the opposite side, these two connector caps 170, 172 only allowing full mating of the optics connector when the connector portion on the left is in one of 12 angular positions relative to the connector portion on the right. For each of these positions, the insertion losses from the coupling were measured as shown in the graphical plot 174 on the right of FIG. 16. Only one of the rotational positions provided the lowest insertion loss of 0.22 dB, and all other positions or angular alignments result in significantly higher insertion losses. Thus, when establishing the rotational or angular alignment of hollow-core optical fibers 30 in the assembly according to the present disclosure, the vision system conducts similar tests to assure that the insertion or reflection losses are minimized through the micro-optics glass plate. The angular alignment, much like the lateral alignment in cases involving lenses or the like, is therefore an important component of achieving the technical benefits of the assemblies and connectors of this disclosure.

The various assemblies and connectors described herein can achieve at least similar results as low-loss connectors used with single-mode fibers. For example, a coupling of a hollow-core optical fiber to a single-mode fiber can achieve a total loss of no more than 0.1 dB, while a connection between two hollow-core optical fibers can achieve a total loss of no more than 0.13 dB. Various features including heat treatment and application of anti-reflective coatings to minimize Fresnel losses may be necessary to achieve such low loss conditions. As such, the benefits of hollow-core optical fibers can be used in more fiber optics systems and contexts using the assemblies herein.

Connecting a micro-optic glass plate by direct bonding to the end face of a hollow-core optical fiber in accordance with the several example embodiments above helps achieve several key functional advantages. These advantages include low coupling loss by mode matching using a micro-optic lens or meta-surface optics in the optical path; low return loss due to angled end faces or anti-reflective coatings; high durability based on use of exclusively non-organic materials in the optical path; high power handling capability again due in part to the use of non-organic materials in the optical path; automated optimizing of positions using a vision system for lateral and angular alignments of fibers on the plate; relaxed lateral alignment tolerances needed for expanded beam interfaces; one-dimensional or two-dimensional connectivity for high density parallel fiber arrays; and standard interface definitions based on mode field diameters. Thus, a robust and optimized connector interface is provided, and the hollow-core optical fibers can be used in many more contexts.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The present disclosure in its broader aspects is therefore not limited to the specific details, representative apparatus and methods and illustrative examples shown and described. Accordingly, departures may be made from such details without departing from the scope of the present disclosure.

What is claimed is:

1. An assembly for use in fiber optics devices, comprising:
a hollow-core optical fiber including an end face at a terminal end; and
a micro-optic glass plate connected to the hollow-core optical fiber, with the micro-optic glass plate being fusion bonded to the end face such that the micro-optic glass plate covers the end face,
wherein the micro-optic glass plate is at least partially optically transparent to transmit light energy to or from the hollow-core optical fiber, and the hollow-core optical fiber is aligned laterally and rotationally in position on the micro-optic glass plate before the fusion bonding to minimize coupling and return losses of light energy transferred through the assembly.

2. The assembly of claim 1, wherein the micro-optic glass plate is selected from a group consisting of a refractive lens, a meta lens, a beam splitter, a planar glass plate, an angled glass plate, a polarizer, and an isolator.

3. The assembly of claim 1, wherein the micro-optic glass plate is laser welded to the end face of the hollow-core optical fiber to fusion bond these elements together, the laser welding producing a bond area that connects and seals the end face to the micro-optic glass plate.

4. The assembly of claim 1, wherein the hollow-core optical fiber comprises an outer cladding surrounding an interior, and the fusion bonded connection between the end face and the micro-optic glass plate is made along a junction of the outer cladding with the micro-optic glass plate; and
wherein the hollow-core optical fiber defines an outer periphery at the outer cladding facing away from the interior, and the assembly further comprises:
adhesive material applied to a junction of the outer periphery and the micro-optic glass plate after the fusion bonding to thereby further connect the hollow-core optical fiber to the micro-optic glass plate.

5. The assembly of claim 1, further comprising:
an anti-reflective coating applied to at least one surface of the micro-optic glass plate to minimize back-reflection of light energy transferred through the micro-optic glass plate;
wherein the micro-optic glass plate includes a first surface connected to the end face of the hollow-core optical fiber and a second surface facing away from the hollow-core optical fiber, and the anti-reflective coating is applied to both of the first and second surfaces of the micro-optic glass plate.

6. The assembly of claim 1, wherein the assembly defines an optical path for light energy transmission, and the assembly consists of only non-organic materials along the optical path.

7. The assembly of claim 1, further comprising:
a plurality of hollow-core optical fibers, each including an end face at a terminal end thereof,
wherein the micro-optic glass plate is connected by fusion bonding to the end faces of each of the plurality of hollow-core optical fibers to produce an array of hollow-core optical fibers connected to the micro-optic glass plate.

8. The assembly of claim 7, wherein the micro-optic glass plate comprises a refractive lens array including one refractive lens for each of the plurality of hollow-core optical fibers connected to the micro-optic glass plate.

9. The assembly of claim 7, wherein the terminal end of each of the plurality of hollow-core optical fibers is angle-cleaved such that the end face of each hollow-core optical fiber is oriented at an angle that is non-perpendicular to a longitudinal length of the hollow-core optical fiber, and wherein the micro-optic glass plate is connected at the angle to each of the plurality of hollow-core optical fibers to minimize back reflection of light energy being transmitted into the micro-optic glass plate.

10. The assembly of claim 1, wherein the micro-optic glass plate comprises one of a lens or a beam splitter, and the hollow-core optical fiber is aligned laterally before fusion bonding such that the lens or the beam splitter is positioned to receive all light energy transferred from the hollow-core optical fiber into the micro-optic glass plate.

11. The assembly of claim 1, wherein the micro-optic glass plate comprises a lens, and the hollow-core optical fiber is aligned rotationally before fusion bonding such that a relative angular position of the hollow-core optical fiber and the lens on the micro-optic glass plate is configured to mode match between these elements to minimize coupling loss of light energy transmitted between the hollow-core optical fiber and the micro-optic glass plate.

12. The assembly of claim 1, wherein the terminal end of the hollow-core optical fiber is angle-cleaved such that the end face of the hollow-core optical fiber is oriented at an angle that is non-perpendicular to a longitudinal length of the hollow-core optical fiber, and wherein the micro-optic glass plate comprises an angled glass plate with one surface angled from an opposing surface and configured for fusion bonding to the angle-cleaved terminal end of the hollow-core optical fiber, thereby minimizing return loss caused by reflections during transmission of light energy between the hollow-core optical fiber and the micro-optic glass plate.

13. An optical connector system for optical data transmission, comprising:
a first assembly comprising a first hollow-core optical fiber including an end face at a terminal end; and a first micro-optic glass plate connected to the first hollow-core optical fiber by fusion bonding such that the first micro-optic glass plate covers the end face, wherein the first hollow-core optical fiber is aligned laterally and rotationally in position on the first micro-optic glass plate before the fusion bonding to minimize coupling and return losses of light energy transferred through the first assembly;
a second assembly comprising a second optical fiber and a second micro-optic glass plate connected to an end face of the second optical fiber at a terminal end thereof; and
a connector body configured to receive the first and second assemblies and position the first and second assemblies to define a free space coupling between the first and second micro-optic glass plates,
wherein at least one of the first and second micro-optic glass plates comprises a lens to guide light energy being transferred between the first hollow-core optical fiber and the second optical fiber through the free space coupling.

14. The optical connector system of claim 13, wherein the second optical fiber is a solid-core fiber comprising an inner core configured to transmit light energy and an outer cladding surrounding the inner core.

15. The optical connector system of claim 13, wherein the second optical fiber is a second hollow-core optical fiber comprising an open interior surrounded by an outer cladding, and the second micro-optic glass plate is fusion bonded to the end face of the second hollow-core optical fiber.

16. The optical connector system of claim 13, wherein each of the first and second assemblies further comprises:
integrated alignment features configured to mate the first assembly to the second assembly only when the first assembly is laterally and angularly aligned with the second assembly to form the free space coupling.

17. A method for preparing an assembly for use in fiber optics devices, the method comprising:
cleaving a hollow-core optical fiber to form a terminal end having an end face defining an opening into an interior of the hollow-core optical fiber;
positioning the end face of the hollow-core optical fiber into contact with a micro-optic glass plate;
aligning the end face of the hollow-core optical fiber into a desired lateral and angular position relative to the micro-optic glass plate; and
connecting by fusion bonding the end face of the hollow-core optical fiber to the micro-optic glass plate, wherein the micro-optic glass plate covers and seals the end face of the hollow-core optical fiber, and the micro-optic glass plate is at least partially optically transparent to transmit light energy to or from the hollow-core optical fiber,
wherein the desired lateral and angular position of the aligning step is configured to minimize coupling and return losses of light energy transferred through the assembly.

18. The method of claim 17, wherein the step of aligning is performed by a vision system to automatically and visually guide the end face of the hollow-core optical fiber into the desired lateral and angular position relative to the micro-optic glass plate.

19. The method of claim 17, wherein the micro-optic glass plate comprises a refractive lens array including one refractive lens for each of a plurality of hollow-core optical fibers, and the method further comprises:
repeating the positioning, aligning, and connecting by fusion bonding steps for each of the plurality of hollow-core optical fibers, to thereby sequentially connect each hollow-core optical fiber and produce an array of hollow-core optical fibers connected and sealed to the micro-optic glass plate,
wherein the aligning step positions each hollow-core optical fiber at an associated one refractive lens of the refractive lens array.

20. The method of claim 17, further comprising, after the connecting by fusion bonding step:
applying an adhesive material to a junction of an outer periphery of the hollow-core optical fiber with the micro-optic glass plate, thereby to increase a strength of connection between these elements.
